(19) United States
(12) Patent Application Publication
(10) Pub. No.: US 2013/0110473 A1
(43) Pub. Date: May 2, 2013

(54) METHOD AND SYSTEM FOR SOLUTION OF MODELS

(71) Applicant: Eduardo Cantu, Monterrey (MX)

(72) Inventor: Eduardo Cantu, Monterrey (MX)

(73) Assignee: ALEPH5, S.A., Monterrey (MX)

(21) Appl. No.: 13/281,566

(22) Filed: Oct. 26, 2011

(51) Int. Cl. G06F 17/10

(52) U.S. Cl. 703/2

(57) ABSTRACT

Methods, apparatuses, and systems are presented to simplify optimization problems in order to reflect the decision strategies of a person or persons (decision makers) while taking advantage of the structure of the underlying mathematical model given by the classification of variables and functions according to their real meaning in the context of the problem. This allows the generation of solutions whose behavior better reflects the necessities of the decision maker in a faster and easier way. At the same time, the generated optimization problems are simplified, making them much easier to construct and solve numerically.

### FIELD

This disclosure relates in general to the computerized mathematical solution of real world problems. More particularly, this disclosure relates to the solution of problems that may have multiple conflicting or partially conflicting objectives.

### BACKGROUND

The use of mathematics as a tool in the understanding of phenomena in many areas in the solution of practical problems or in the support of decisions is well established. The community in most of these areas appreciates at least the mathematical methods most applied in their problems, if not the whole of the. mathematical discipline.

Despite the fact that many well-studied problem situations have been the center of research efforts, and many computational tools and commercial and free software has been around for many years to assist in the solution of problems or to support the decision process, in many cases such tools tend to be applied without the proper understanding of their behavior. This can lead to incorrect solutions or solutions with little practical utility.

This is unfortunate because in the minds of administrators and business people, these failures are often not in the people implementing the solutions, but in the very methods themselves. Many such people make claims like “heuristics are useless” or “multivariate analysis is not an appropriate method in our business,” with no real understanding of the methods they are disparaging.

Many commercial products for industrial applications make use of modeling and optimization techniques, but none of them make use of the methods and techniques described in this disclosure. Algorithm providers are typically concerned only with optimization techniques and the robustness of the algorithm. Modeling language providers are typically concerned only with the ability to create models from data sets. The assumption that models are solved by algorithms in a straightforward way is common, but this assumption has proved wrong in practice.

The complexity of real problems, including multiple objective and fuzzy, subjective criteria, has not been incorporated in commercial applications because the shortcomings of the available techniques.

This being the case, it is advantageous to develop tools and a methodology to simplify the proper use of mathematical models in the process of supporting decisions in practical frameworks, especially for persons with lower levels of mathematical sophistication.

This disclosure relates to such tools. The particular computational tool disclosed herein was designed to exploit the possibilities and valuable use of mathematical decision models and their practical use, the proper interpretation of the solutions obtained, and the adequate choice of elements of the models.

### SUMMARY

According to one aspect of this disclosure, methods, apparatuses, and systems are disclosed for the solution of mathematical models. Such solutions involve a model, which is generally a collection of mathematical objects representing an optimization problem and at least one objective to be maximized or minimized. A strategy is defined, which involves manipulating the model via a computerized set of steps. A model structure is defined, which is used in manipulating the model according to the strategy.

In this way, the model may be manipulated as desired according to the strategy and then passed to a standard computerized solver program. Once the solver has optimized the model as directed by the strategy, the solution may then be used to construct additional solutions in a way that is advantageous and relatively simple for the operator by, for example, fixing certain variables and then optimizing for a different objective.

### BRIEF DESCRIPTION OF THE DRAWINGS

The features, nature, and advantages of the disclosed subject matter will become more apparent from the detailed description set forth below when taken in conjunction with the drawings, in which like reference numerals indicate like features and wherein:

FIG. 1A shows a schematic contrasting prior art methods for problem solving with the present disclosure;

FIG. 1B shows different classifications of solutions according to the present disclosure;

FIG. 1C shows distinctions among the possible universe of solutions to a problem;

FIG. 2 shows the meta-algorithm environment of the present disclosure as a component of a larger software suite;

FIG. 3 shows some components of an embodiment of the present disclosure;

FIGS. 4-5 show the relationships between the inputs accepted by the systems of the present disclosure;

FIG. 6 shows a high-level view of the interaction between an execution engine, a solver, and inputs;

FIG. 7 shows an exemplary computer system in accordance with the present disclosure;

FIG. 8 shows different components of the present disclosure running on physically separate computers;

FIGS. 9-12 show process flows for the execution of the methods of the present disclosure;

FIG. 13 shows different solutions of the type that might be generated by the present disclosure;

FIG. 14 shows steps from a particular pre-built strategy;

FIG. 15 shows a screenshot of a comparison between different solutions; and

FIG. 16 shows a screenshot of a meta-modeling environment according to the present disclosure.

### DETAILED DESCRIPTION

Although the present disclosure is described with reference to specific embodiments, one skilled in the art could apply the principles discussed herein to other areas and/or embodiments without undue experimentation.

For hundreds of years and especially since the invention of the computer, mathematical methods have been applied for the solution of practical problems and the study of real phenomena. The use of computer methods generally becomes mandatory as the number of factors involved in the real situation grows and the relations between them become sufficiently complex.

For the sake of concreteness and brevity, this disclosure will rely on the following definitions.

DEFINITION 1: We understand a mathematical model as a set of mathematical objects which are associated with certain aspects of a real situation or problem.

Mathematically, a model is nothing more than a set of mathematical objects, and the model has meaning only from the point of view of a person. We do not make distinction here between “good” models and “bad” models. The representation of the reality in a mathematical model, that is, the design of mathematical models to accurately represent a reality is often considered a kind of art, cultivated mainly with experience. Besides, the goodness or badness of a model depends strongly on the real goals of the situation, not only on the mathematical concepts. It may be worth mentioning that any model of a real situation necessarily considers only certain aspects of the reality and only in an approximated way. Several aspects are not included in the model, but it is assumed that even with such a simplification the model is useful for the practical problem.

We consider “mathematical objects” to include those well accepted in the mathematical community, e.g. numbers, equations, inequalities, relations, functions, sets, etc. As a special kind of mathematical model we describe a mathematical decision model as a model including a set of functions associated with quantities whose values it is desirable to minimize (or maximize).

DEFINITION 2: A mathematical decision model (decision model), is a mathematical model including a set of functions and a set of numbers/variables. The functions are associated in reality with quantities to be minimized (or maximized) via choosing values for the variables. The functions are called objective functions, and the variables are decision variables, which are the free variables of the model.

In general, a decision model may include other mathematical objects, usually equations and inequalities associated with balance principles, laws, restrictions or limits of the real situation. It may be important to clarify that those definitions depends on the associations made between mathematical objects and the reality. In the optimization literature, a feasible solution is a set of values for the decision variables respecting the set of constraints. And for decision models with a single objective function, an optimal solution is a set of values for the decision variables, respecting the given constraints while minimizing (or maximizing) the value of that objective function.

For practical purposes it may be convenient to consider another set of mathematical objects associated to the real situation, that is to say, a model structure associating the model variables and other objects with the important quantities of the real situation.

DEFINITION 3: Given a decision model associated with a real situation, we define a mathematical model structure (model structure) as a collection of sets. The elements of the sets'are associated with the mathematical objects of the decision model according to a classification of the real situation. In this way, the model structure provides a sort of index or dictionary into the (potentially huge number of) objects in the decision model, connecting them to the figures of merit in the real situation. The representation rules of the model structure allow translation between the model structure and the model. For example, a variable representing total sales the model might have an automatically generated name such as “x543312” which would be meaningless to someone writing a strategy. But the model structure acts as a dictionary to translate between the terms used by the strategy and the terms used by the model. This allows a solution strategy to be written in terms of those figures of merit, without getting bogged down in the details of an enormous decision model.

If we consider all the variables, constraints, and objective functions involved in a decision model associated with a real situation, and if such objects are associated with aspects of the reality in a given way, then such a classification defines a collection of sets for the objects. This classification is given in the context of the real situation. In an example below, a classification of variables, restrictions and objectives is presented for a real situation, namely a supply chain decision model.

This allows the definition of a more interesting mathematical model to represent the required behavior of a solution according to the opinion of the owner of the problem or experts in the real situation, in terms of the figures of merit in the real situation. This expected behavior is strongly related to the model structure, where the owner may define preferences or other required behaviors.

A model structure may be considered to be a specific embodiment of a more general concept known as a meta-model. A meta-model applies to broad classes of problems and describes the relationships between the various classes of variables and other mathematical objects.

DEFINITION 4: We define a mathematical solution strategy (solution strategy or simply strategy) as a sequence of transformations:

S₁, S₂, . . . Sₙ

between mathematical models. Each transformation Sᵢ: Qᵢ→Ωᵢ₊₁ has a given domain representing the set of models allowed to be transformed.

It is not a requirement of the present disclosure, but the transformations usually are expressed in terms of the model structure. Its effect in the strategy only becomes evident after defining each transformation step. An example of this observation is presented below.

It should be noted that not just any mathematical model can have the transformations of the strategy applied to it. Given an initial/original model and a strategy, the transformations generate a sequence of mathematical models,

M₁→M₂→M₃→ . . . Mₙ₊₁

The idea of a strategy is that the sequence of transformations represent the logic behind the decision making process of the experts in the situation, in such a way that the solution of the final model becomes a practical solution from the point of view of the owner of the problem.

A solution is obtained based on the solution strategy. This solution will have some qualitative characteristics according to the opinion of the owner of the problem. The solution may be classified as practical, adequate, useful, etc. At this point the system may help the owner to improve an already computed solution via altering the decision strategy or in the worst case by adding or removing elements of the mathematical model.

Again, we do not discuss here the design of “good” strategies or “bad” strategies and simply assume that the strategies under discussion really represent the way experts make decisions. Nevertheless, an example from a real industrial problem where each of the concepts are used may be found below.

For generality, what follows is a high-level, abstract description of the aspects of a common problematic situation. This may aid in seeing the problem from the perspective of a non-academic person who wants to solve a practical problem. The ability to understand the problems as the owner of the problem does is a fundamental and very rare characteristic in a scientist or mathematician and is the main reason mathematics fails in practice in such situations. This section describes the traditional approach and our novel approach to the use of mathematical models to cope with the necessities of the owner of the problem and the general form of such a methodology together with the justification of this form of confronting the problem.

Assume we have a decision model for a given real situation where several decision variables represent quantities whose values must be chosen:

x₁, x₂, . . . , xₙ

Assume further that a set of constraints (equalities and inequalities) is designed to represent some conditions on the situation,

c₁, c₂, . . . , cₘ

Also, a set of objective functions is considered to evaluate or assess the situation,

f₁, f₂, . . . , fₖ

This set of mathematical objects represents a decision model. If several objective functions are present, it is a multi-objective model. The design of such a model requires a certain level of mathematical maturity and a given expertise in the field of the real problem.

There are currently two main popular approaches to “solve” such kinds of models. The first is to design a certain sort of aggregated function using all the objective functions (e.g. a weighted sum or any other kind of combination of the functions). This approach has been criticized in many ways, because the construction of aggregated functions representing the real desired behavior is very complex. A second approach is to consider the full multi-objective model, so that a “solution” becomes not a point but a manifold (a whole set of solutions), and the idea is to design tools to navigate such a set and let a person make the final decision as to which solution is most appropriate. The problem here is that even for a few objective functions, several problems need to be solved, and usually far too many solutions are generated. Additionally, for complex problems, the time required to analyze a single solution is considerable, so typically only a small number of solutions are analyzed.

In short, the traditional approach is either to construct a single problem using the expert knowledge of the decision maker, or to involve the decision-making experts after solving several optimization problems.

The method presented in this disclosure is neither to construct a single problem nor to construct a large set of solutions. We encapsulate the decision-making knowledge in the solution strategy and make use of the decision model to construct a sequence of optimization problems to obtain a solution more appealing to the owner of the problem. The strategy depends on the model structure, and if properly designed, the strategy can generate solutions with a given desired behavior.

This disclosure describes a novel approach to solving real world problems using mathematical modeling and optimization techniques. It manages multiple objectives, traditional constraints, and subjective criteria simultaneously, based on the structure of the model. This disclosure is based on the idea that this structure represents the solution characteristics so that the strategies can take advantage of this structure to generate useful solutions. Based on the real structure of the problem, the strategies find solutions with the expected qualitative and quantitative behavior required by the decision maker.

A solution's behavior is critical in all real world applications and a robust solution strategy can generate useful solutions that do not depend on tinkering with the decision model.

Solution strategies are based on the observation that in order to find practical and useful solutions, a sequence of related models should be solved. This disclosure takes advantage of the known structure to perform the optimization steps efficiently. The strategies also allow the exploration of the neighborhood of the solutions and allow the relaxation of an objective as a useful option for the constructions of new strategies.

This disclosure encapsulates the optimization and mathematical techniques in a way that effectively hides them from a non-expert decision maker. In this way, non-experts may define strategies to generate useful solutions that meet all expected characteristics without modifying the mathematical model or the algorithms used to solve the generated optimization problems. All disclosed concepts are implemented in a tool that enables the application of the methods and simplifies the integration with available modeling and optimization technologies.

Assume that each of the n variables of the decision model represents a quantity classified in a class in the real problem. We can define this properly as a collection of sets:

A₁, A₂, . . . Aₚ

Where each set Aᵢ ⊂ N represents the indices of the objects within a certain class i. If only n objects appear in the model, we expect only sets of numbers less than or equal to n. We refer to a class as a part of the reality for the given situation. The classification of objects from the point of view of the real situation may become much more complex, but in this example we assume only a partition of classes. In a supply chain problem, for example, the classes might divide the objects into categories like inventory variables, production constraints, sales variables, business objectives, etc.

Finally, a solution strategy is defined given a decision model and a model structure. Each transformation in the strategy makes use of part or parts of these models. Consider a strategy

S₁, S₂, . . . , S_{q}

as a sequence of model transformations where each transformation is defined in terms of the decision model via the model structure.

As an illustration, let M₁ be a decision model and consider the next transformation.

S₁(M₁)=M₂

Where the model M₂ is obtained via the following steps:
1. Solve optimization problem given by M₁ but only for the first objective function f₁.
2. Get values of variables on set A₃.
3. Construct a model M₂ where the values of the variables in A₃ are restricted according to their values obtained in step 1.

As we see, even such a simple transformation is not easy to express in a single line, and a list of tasks is required to define the transformation. But such tasks are much more related to the real situation and may be interpreted in real language. (This principle will be illustrated more concretely below.) Note also that the second model could be smaller than the first one, having fewer free variables.

Other transformations are defined in similar ways and are expected to produce at the end a solution with characteristics desired by the owners of the problem. Further, each strategy is related by a certain way of making decisions. In practice, several different strategies may be used to reflect different ways of making decisions; as in the example above, it might be advantageous to optimize first for a given objective, set a range for some variables, and then re-optimize for a different objective. We can then compare different solutions according to different strategies or change the strategy after a period of time has elapsed and new strategies are required, without explicitly constructing a new decision model. This allows a decision maker to dynamically change requirements and react quickly to a changing situation, in a way that is not possible with prior-art systems.

A strategy is a defined method to solve optimization problems in steps. The different procedures executed at each step are the ones that give each strategy the ability to generate results with specific characteristics.

By transferring the complexity from the model to the procedure used to explore the solution space, it is possible to obtain results in a much more efficient way that adheres to the requirements imposed by the business or real world needs.

By using such strategies, the present disclosure tries to capture the business and real world meaning of a problem and embed it into the solution strategy, encapsulating the mathematical complexity outside the decision model. Some problems may require the use of different strategies applied to the same model to generate the right solution(s).

Strategies have as their main components objective functions, policies, and goals, which are defined based on sets of model variables.

In general an objective function does not have a known value, but rather is a function to be optimized by the strategy and takes values generated by the optimization process.

A policy is an equation in the model variables that is expected to take a known or unknown minimum or maximum target value and the deviations with respect to this target should be minimized, subject to the constraint that the value of the function should not fall below the target minimum (or exceed the target maximum).

For goals, a target known or unknown target value exists, and positive and negative deviations from that value should be minimized. It may be desirable to stay within a known range of that target value.

The present disclosure enables the definition and coding of solution strategies that solve mathematical models with a known structure through the use of meta-algorithms that manage the model-solver interaction. This allows an efficient integration and utilization of several optimization technologies and avoids the need of expertise to properly use them. This disclosure enables non expert users to apply mathematical techniques that solve real problems in an easy and user-friendly way.

While prior-art techniques allow the identification of the set of optimal or at least feasible solutions, identifying and selecting among those the solution that better fits an expected behavior can be extremely difficult if not impossible, because from a mathematical standpoint all those solutions are equally good.

The approach presented here preserves the meaning of the elements of the business or real problem by embedding it into the strategy. It is precisely that knowledge that allows the strategy to explore the qualities of the solutions that are evident only after we reassign them the meaning that was lost while modeling. Once we consider the meaning of the solution, it is possible to further identify and classify the optimal or feasible solutions.

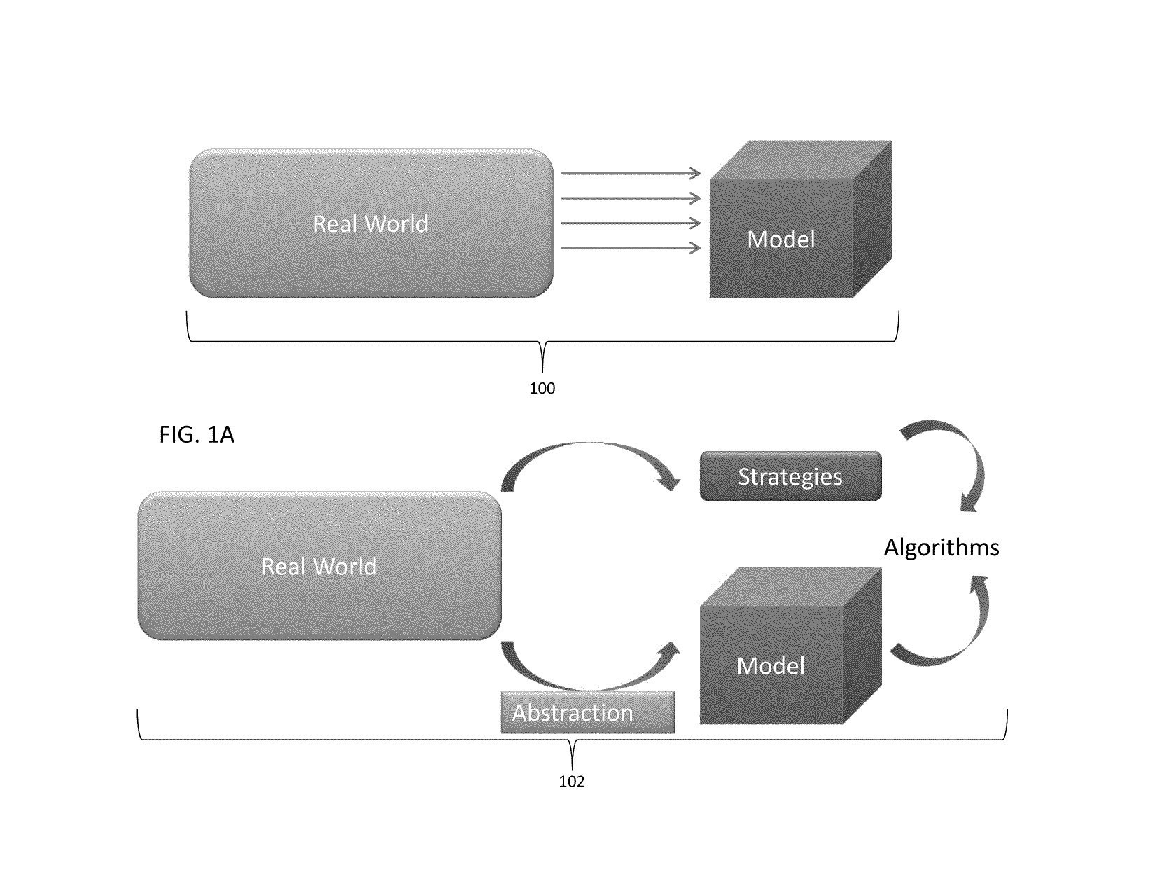

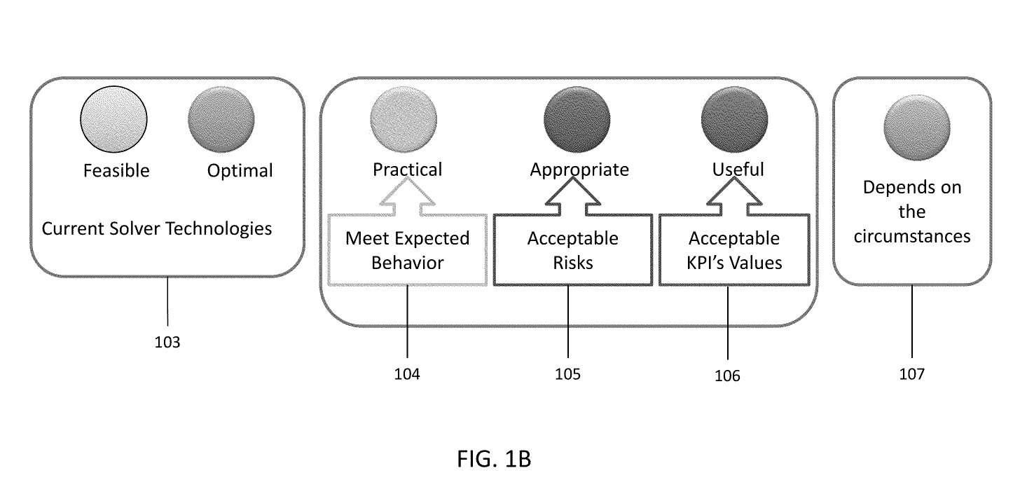

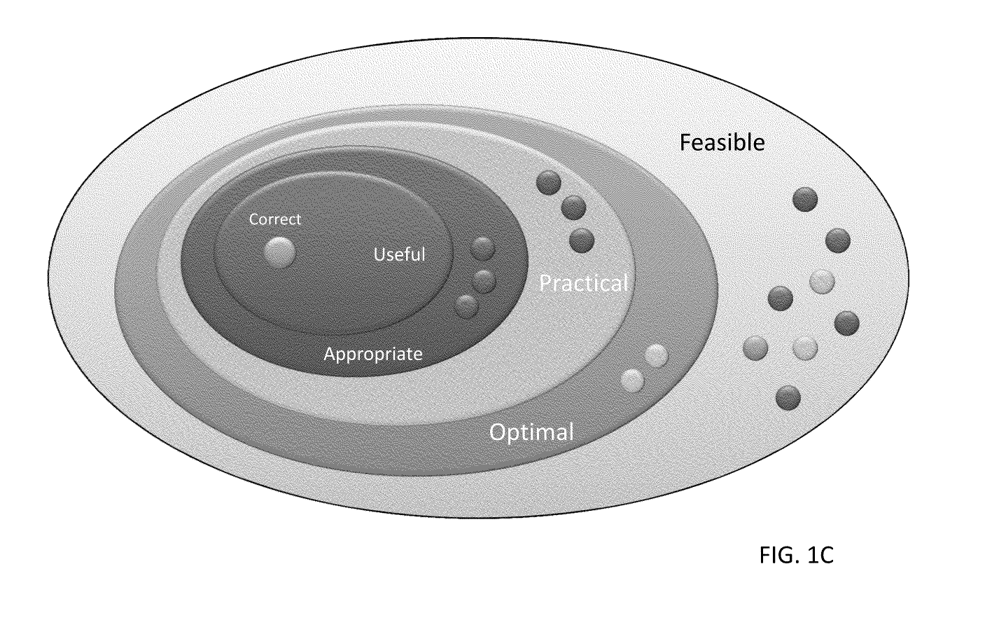

This is illustrated schematically in FIG. 1A. In traditional approach 100, all the information about the real world problem (including the variables, constraints, objective functions, strategies, and algorithms) is encoded in the model. However, in approach 102, consistent with the present disclosure, much information about the real world problem (such as the meaning of the variables and knowledge about desired solution behaviors) are embedded into the strategy instead of becoming part of the model.

As shown in FIG. 1B, the present disclosure goes beyond known techniques, which only provide a (generally large) set of feasible or optimal solutions 103. In a first stage the solutions that adhere to an expected behavior are selected; those solutions represent the set of practical solutions 104.

Due to the assignment of meaning to the strategy it is possible to identify risks in the quality of the solution. Therefore the risks implied by each solution in the set of practical solutions are analyzed, and those that have an acceptable risk level are selected to comprise the set of appropriate solutions 105.

The key performance indicators (KPIs) are analyzed for the solutions contained in that appropriate solutions set. Those that meet the values defined by the problem owner are selected as members of the useful solutions set 106. So this approach allows us to transition from a set of feasible and optimal solutions to a much narrower universe of useful solution. Once the useful solutions are presented to the problem owner he or she may select the one that is most favorable under the given circumstances. That solution is named the correct solution 107.

FIG. 1C shows a different schematic view of the same distinctions in the universe of possible solutions. The solution set is narrowed from feasible to optimal to practical to appropriate to useful, and finally to the correct solution.

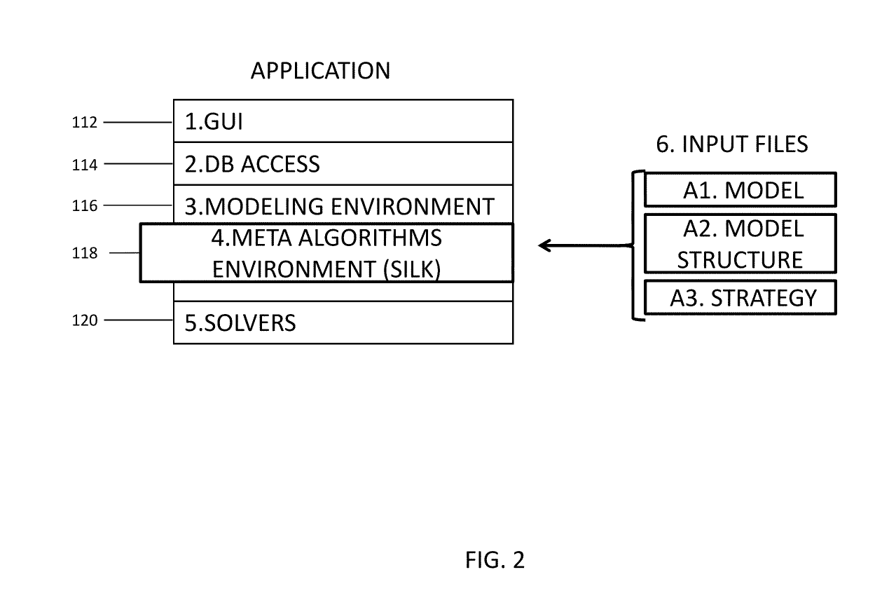

In one embodiment, demonstrated in FIGS. 2, 4, 5, and 6, the execution engine of the present disclosure receives as an input 3 files:
A1. The mathematical model
A2. Model structure file
A3. Solution strategy

This approach allows the decoupling of the definition of the strategy from the model to represent a problem in a generic way.

Each file may be generated by other methods or software or even typed manually by a person in some simple cases. The implementation details of the format of each of these files are not essential to this disclosure, but some of the information that may be included in each file is described below.

The file A1 contains mathematical objects (such as equations, inequalities or functions) supposedly reflecting the relationships between the variables of a given real situation or problem. Some typical examples of implementations of these files are MPS and LP which are standard formats for linear programming models.

The file A2 contains a list of classes that refer to a set of variables in the model. Each class is then connected to the strategies through the use of aliases used by the strategy commands.

The file A3 contains a list of instructions (generally written in a DSL) representing a solution strategy. This strategy should reflect the logic used by a user to elect solutions in a decision problem that meet the expected behavior.

The instructions of the strategy may be written in a domain-specific language (DSL) and are carried out by an execution engine. In one embodiment, the language is referred to as Silk, and the execution engine is referred to as the Silk Engine. The elements of the DSL may be grouped broadly into the following categories:
Logical Operators
Control Structures
Arithmetical Operators
Logical Operators
Types
Expressions
Functions
Solver Interaction Functions
Restrictions Properties
Variables Properties
Optimization Attributes

Table 1 below shows an exemplary list of some of the instructions that may be implemented in the DSL, what category they fall into, and what section of the input (model, model structure, and/or strategy) they operate against.

TABLE 1

| SECTION | INSTRUCTION TYPE | RESERVED WORD |
|---|---|---|
| STRATEGY | ARITHMETICAL OPERATOR | − |
| STRATEGY | ARITHMETICAL OPERATOR | * |
| STRATEGY | ARITHMETICAL OPERATOR | / |
| STRATEGY | ARITHMETICAL OPERATOR | + |
| STRATEGY | CONTROL STRUCTURE | EXIT |
| STRATEGY | CONTROL STRUCTURE | FOR |
| STRATEGY | CONTROL STRUCTURE | HALT |
| STRATEGY | CONTROL STRUCTURE | IF-ELSE-ELSE IF |
| STRATEGY | CONTROL STRUCTURE | SILK_INCLUDE |
| STRATEGY | FUNCTION | AVG |
| STRATEGY | FUNCTION | COUNT |
| STRATEGY | FUNCTION | ISTYPE |
| STRATEGY | FUNCTION | MAX |
| STRATEGY | FUNCTION | MIN |
| STRATEGY | FUNCTION | OPERATEARRAYS |
| STRATEGY | FUNCTION | PROD |
| STRATEGY | FUNCTION | RESIZEARRAY |
| STRATEGY | FUNCTION | SILK_ERROR |
| STRATEGY | FUNCTION | SILK_WRITE_CSV_RESULTS |
| STRATEGY | FUNCTION | SILK_WRITE_RESULTS |
| STRATEGY | FUNCTION | SILK_WRITE_STATS |
| STRATEGY | FUNCTION | SUM |
| STRATEGY | LOGICAL OPERATOR | != |
| STRATEGY | LOGICAL OPERATOR | < |
| STRATEGY | LOGICAL OPERATOR | <= |
| STRATEGY | LOGICAL OPERATOR | == |
| STRATEGY | LOGICAL OPERATOR | > |
| STRATEGY | LOGICAL OPERATOR | >= |
| STRATEGY | LOGICAL OPERATOR | AND |
| STRATEGY | LOGICAL OPERATOR | NOR |
| STRATEGY | LOGICAL OPERATOR | NOT |
| STRATEGY | LOGICAL OPERATOR | OR |
| MODEL STRUCTURE, STRATEGY | OPTIMIZATION ATTRIBUTE | MAX |
| MODEL STRUCTURE, STRATEGY | OPTIMIZATION ATTRIBUTE | MIN |
| STRATEGY | RESTRICTION PROPERTY | LHS |
| STRATEGY | RESTRICTION PROPERTY | RHS |
| STRATEGY | SOLVER INTERACTION FUNCTION | SILK_GET_PARAM |
| STRATEGY | SOLVER INTERACTION FUNCTION | SILK_GET_SOLVER_PARAM |
| STRATEGY | SOLVER INTERACTION FUNCTION | SILK_GETBASE |
| STRATEGY | SOLVER INTERACTION FUNCTION | SILK_GETOF |
| STRATEGY | SOLVER INTERACTION FUNCTION | SILK_GETRNG |
| STRATEGY | SOLVER INTERACTION FUNCTION | SILK_GETVAR |
| STRATEGY | SOLVER INTERACTION FUNCTION | SILK_GETVARARRAY |
| STRATEGY | SOLVER INTERACTION FUNCTION | SILK_OPTIMIZE |
| STRATEGY | SOLVER INTERACTION FUNCTION | SILK_SAVE_RESULTS |
| STRATEGY | SOLVER INTERACTION FUNCTION | SILK_SAVE_RESULTS |
| STRATEGY | SOLVER INTERACTION FUNCTION | SILK_SAVE_STATS |
| STRATEGY | SOLVER INTERACTION FUNCTION | SILK_SAVE_STATS |
| STRATEGY | SOLVER INTERACTION FUNCTION | SILK_SET_ALPHA |
| STRATEGY | SOLVER INTERACTION FUNCTION | SILK_SET_GOAL |
| STRATEGY | SOLVER INTERACTION FUNCTION | SILK_SET_GOAL_BOUNDS |
| STRATEGY | SOLVER INTERACTION FUNCTION | SILK_SET_OF |
| STRATEGY | SOLVER INTERACTION FUNCTION | SILK_SET_OF_BOUNDS |
| STRATEGY | SOLVER INTERACTION FUNCTION | SILK_SET_PARAM |
| STRATEGY | SOLVER INTERACTION FUNCTION | SILK_SET_SOLVER_PARAM |
| STRATEGY | SOLVER INTERACTION FUNCTION | SILK_SETBASE |
| STRATEGY | SOLVER INTERACTION FUNCTION | SILK_SETVAR |
| STRATEGY | SOLVER INTERACTION FUNCTION | SILK_SETVARARRAY |
| STRATEGY | SOLVER INTERACTION FUNCTION | SOLS_GETSETS |
| MODEL STRUCTURE | TYPE | GOAL |
| MODEL | TYPE | IDX |
| STRATEGY | TYPE | LOCAL_BASE |
| STRATEGY | TYPE | LOCAL_DOUBLE_ARRAY |
| STRATEGY | TYPE | LOCAL_DOUBLE_MATRIX + D60 |
| STRATEGY | TYPE | LOCAL_DOUBLE_VAR |
| STRATEGY | TYPE | LOCAL_INT_VAR |
| MODEL | TYPE | LP |
| MODEL STRUCTURE | TYPE | MATRIX_ARRAY |
| MODEL | TYPE | MPS |
| MODEL STRUCTURE, STRATEGY | TYPE | OBJS_ARRAY |
| MODEL STRUCTURE, STRATEGY | TYPE | OF |
| MODEL STRUCTURE, STRATEGY | TYPE | OF_ARRAY |
| MODEL STRUCTURE, STRATEGY | TYPE | RNG |
| MODEL STRUCTURE | TYPE | SETS_PROPERTIESARRAY |
| MODEL STRUCTURE, STRATEGY | TYPE | SOLOBJS_ARRAY |
| MODEL STRUCTURE, STRATEGY | TYPE | SOLS_ARRAY |
| MODEL STRUCTURE | TYPE | SOLS_GETSETS |
| MODEL | TYPE | STR |
| MODEL STRUCTURE, STRATEGY | TYPE | VAR |
| MODEL STRUCTURE, STRATEGY | TYPE | VAR_ARRAY |
| MODEL STRUCTURE, STRATEGY | VALUE | NULL |
| MODEL STRUCTURE, STRATEGY | VARIABLE PROPERTY | LB |
| MODEL STRUCTURE, STRATEGY | VARIABLE PROPERTY | LUB |
| MODEL STRUCTURE, STRATEGY | VARIABLE PROPERTY | OF |
| MODEL STRUCTURE, STRATEGY | VARIABLE PROPERTY | UB |
| MODEL STRUCTURE, STRATEGY | VARIABLE PROPERTY | VALUE |

Table 1 demonstrates some examples of the types of things that may advantageously be accomplished within the DSL of the present disclosure. The details of these instructions, however, are not vital to the spirit of this disclosure or the scope of the claims.

FIG. 2 highlights the Silk meta-algorithm environment 118 as a part of a larger application suite comprising all components necessary for problem solving. GUI 112 provides data manipulation and solution analysis; DB Access 114 (or data files) provides data integration and validation; modeling environment 116 provides a modeling language for model construction from databases; and solvers 120, which in some embodiments may be separate off-the-shelf components, embody the mathematical algorithms used to optimize a particular objective function.

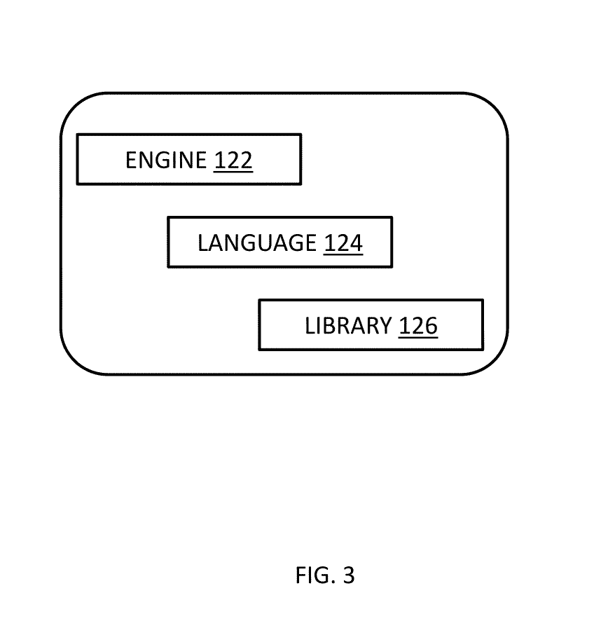

FIG. 3 shows three connected components of the present disclosure. Engine 122 performs three basic functions: syntax validation for user-defined strategies, data consistency validation for runtime operation (consistency among the model, model structure, and strategy), and execution of the instructions in the strategy. Language 124, of which one embodiment is discussed in Table 1, is a DSL that provides instructions to define and build generic strategies. Strategy library 126, discussed in more detail below, provides a set of available strategies to be executed by the execution engine.

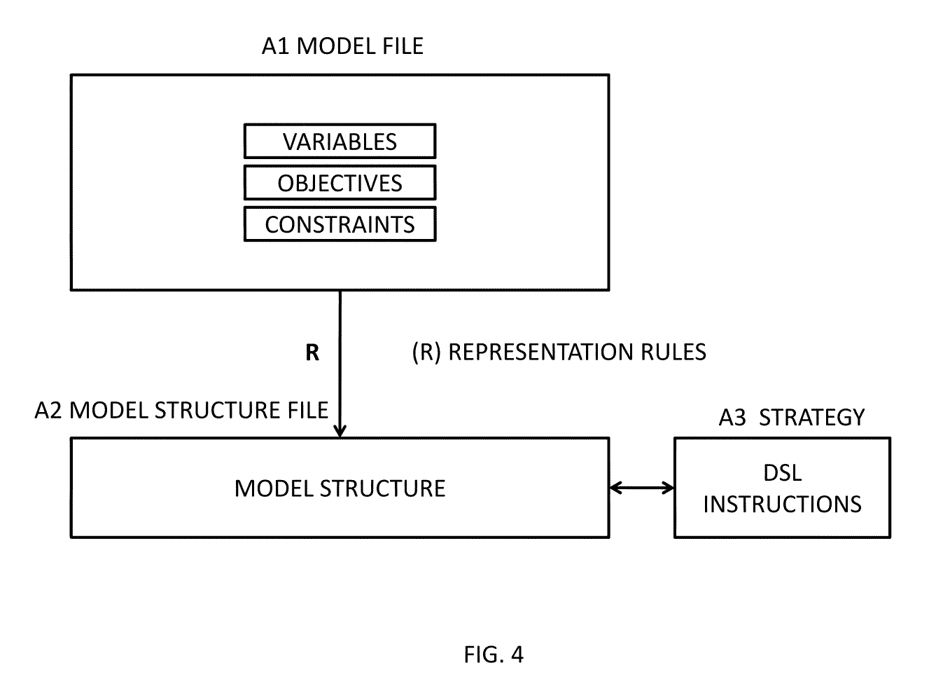

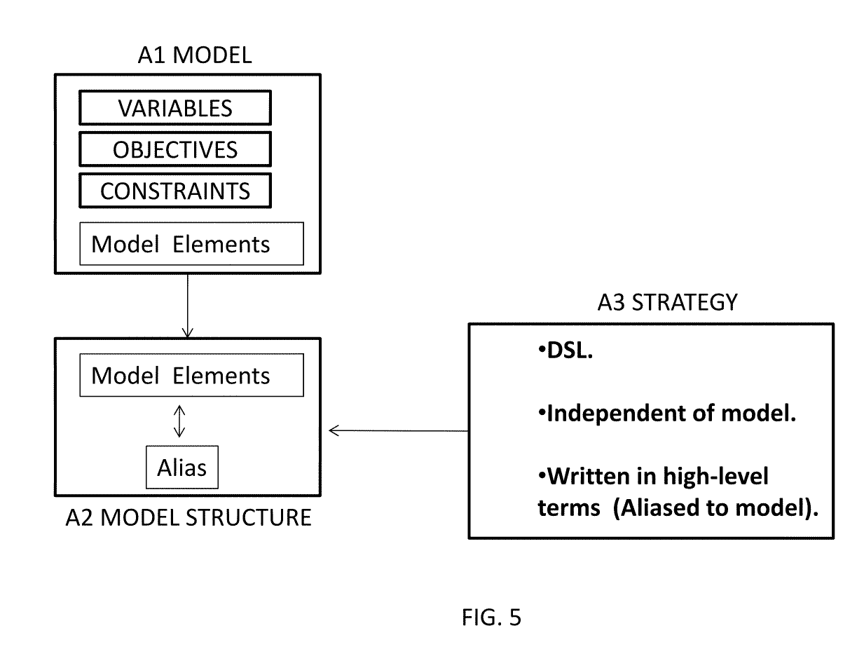

FIG. 4 and FIG. 5 show the relationship between the three inputs A1, A2, and A3 to engine 122. The representation rules used to define file A2 allow translation between the many objects in the model and the higher-level instructions in the strategy.

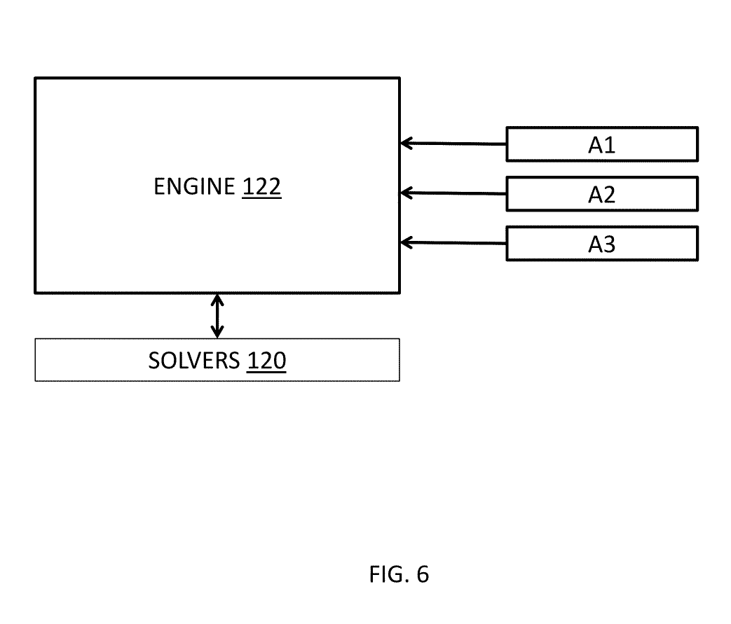

FIG. 6 shows a less detailed view of the interaction between execution engine 122 and solvers 120. Engine 122 identifies the model in input A1, reads, the expected model structure from input A2, and validates that the model is consistent with that model structure. It then executes the instructions in input A3 (the strategy), including calls to the external solvers 120. Solvers 120 could of course be integrated with engine 122, but for the sake of versatility it may be advantageous to have a separate component.

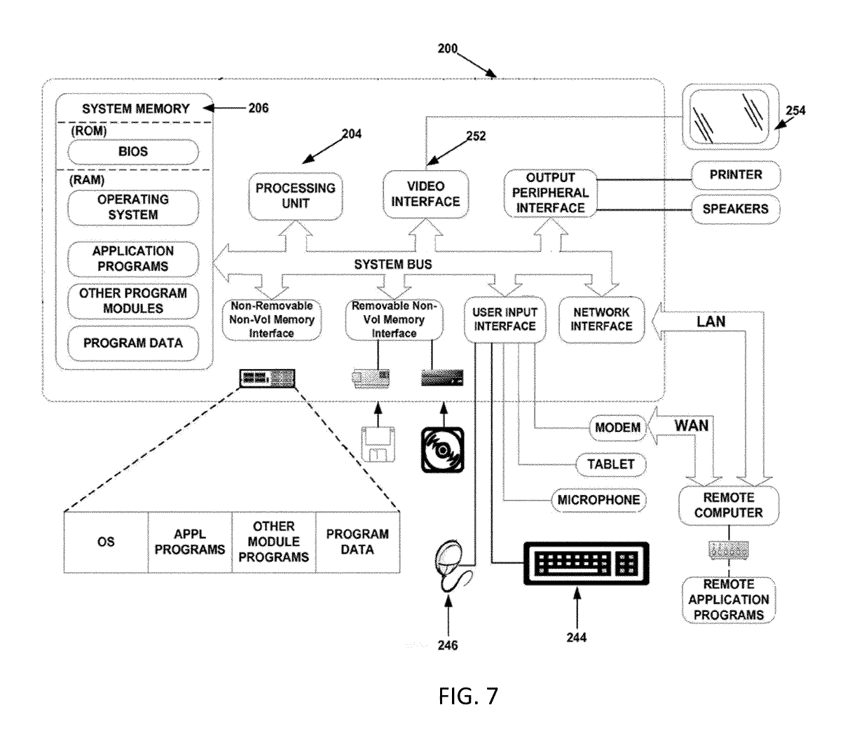

FIG. 7 shows an exemplary computer system for implementing the disclosed subject matter, which includes a general purpose computing device in the form of a computing system 200, commercially available from Intel, IBM, AMD, and others. Components of the computing system may include, but are not limited to, a processing unit 204, a system memory 206, and a system bus 236 that couples various system components. Computing system 200 typically includes a variety of computer readable media, including both volatile and nonvolatile media, and removable and non-removable media. Computer memory may include, but is not limited to, RAM, ROM, EPROM, EEPROM, flash memory, or other memory technology, CD-ROM, DVD, or other optical disk storage, magnetic disks, or any other medium which can be used to store the desired information and which can be accessed by the computing system. A user may enter commands and information into the computing system through input devices such as keyboard 244, mouse 246, or other interfaces. Monitor 254 or other type of display device may also be connected to the system bus via interface 252. Monitor 254 may also be integrated with a touch-screen panel or the like. The computing system may operate in a networked environment using logical connections to one or more remote computers. The remote computing system may be a personal computer, a server, a router, a network PC, a peer device or other common network node, and typically includes many or all of the elements described above relative to the computing system.

A computing device such as the one shown in FIG. 7 may be used to implement various parts of the software of the present disclosure.

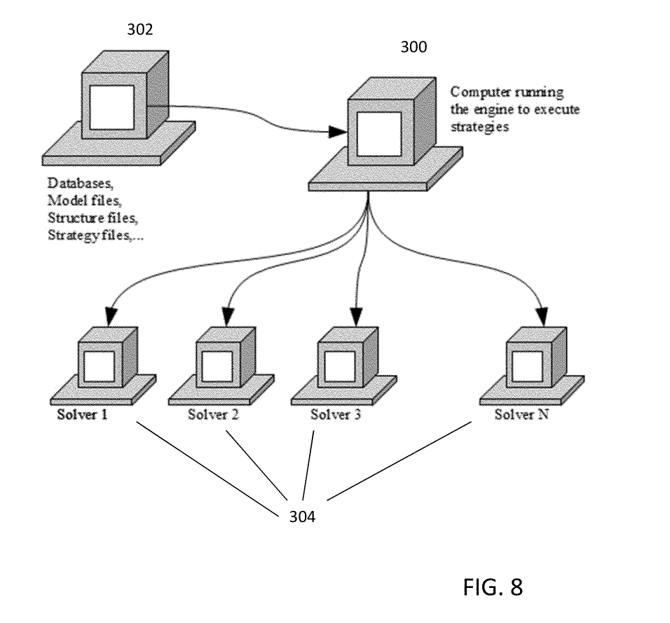

As discussed above, it may be advantageous to have the solver component(s) of the present disclosure exist as separate aspects instead of being integrated with the execution engine, as demonstrated in FIG. 8, where it is clear that there may be advantages to compartmentalizing the different functions of the present disclosure. Computer 300 contains the main execution engine, and it draws its inputs from a separated computer 302. Then the calls to the solvers are actually executed on a plurality of other computers 304 for the sake of efficiency.

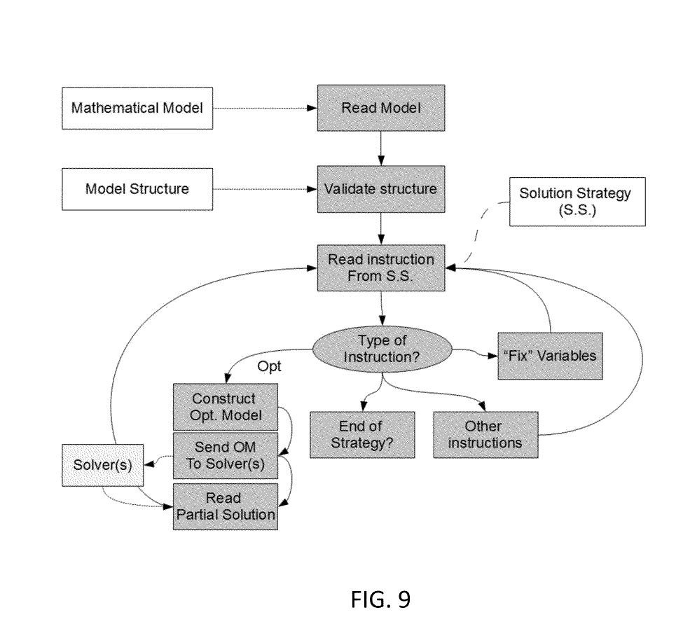

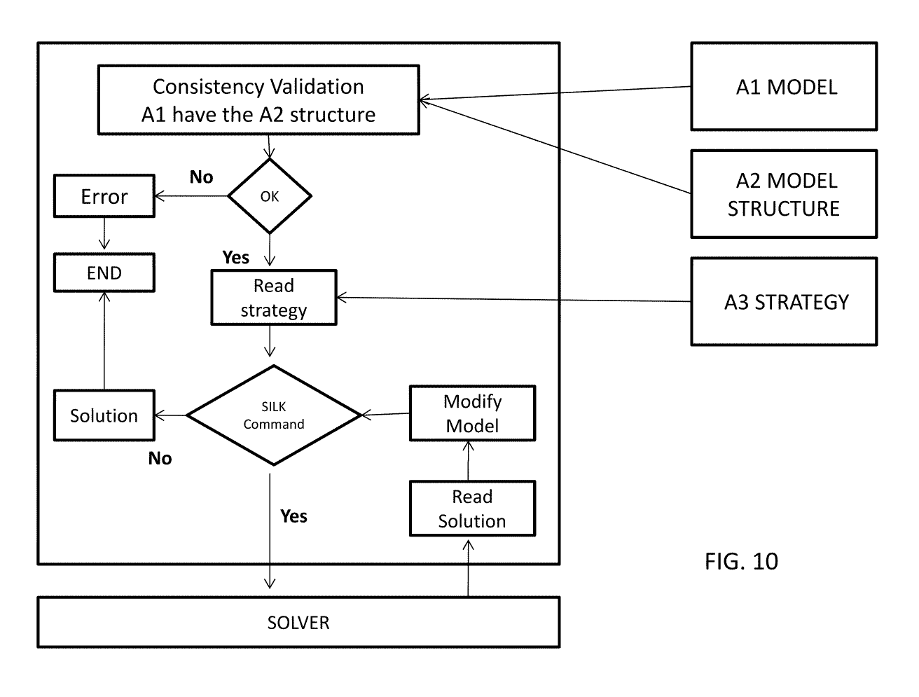

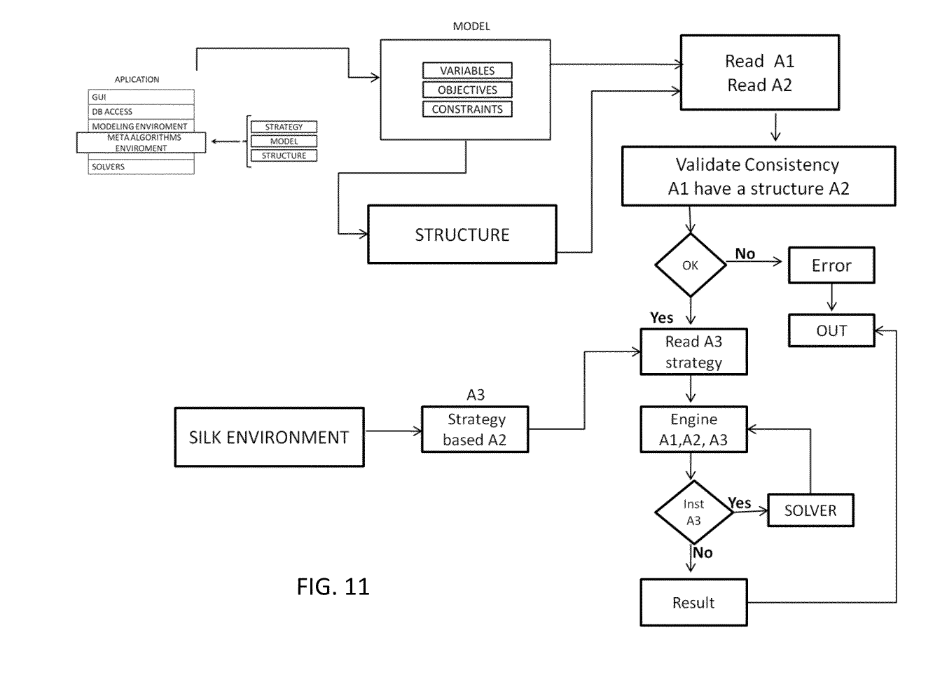

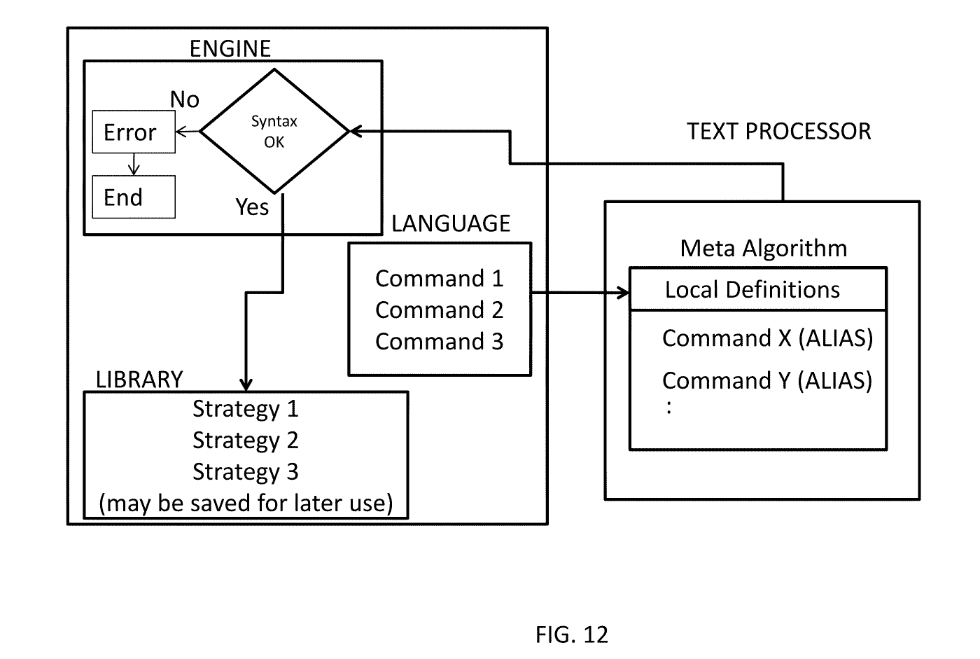

FIGS. 9, 10, 11, and 12 show process flows at varying levels of detail that show the operation of the execution engine described in this disclosure.

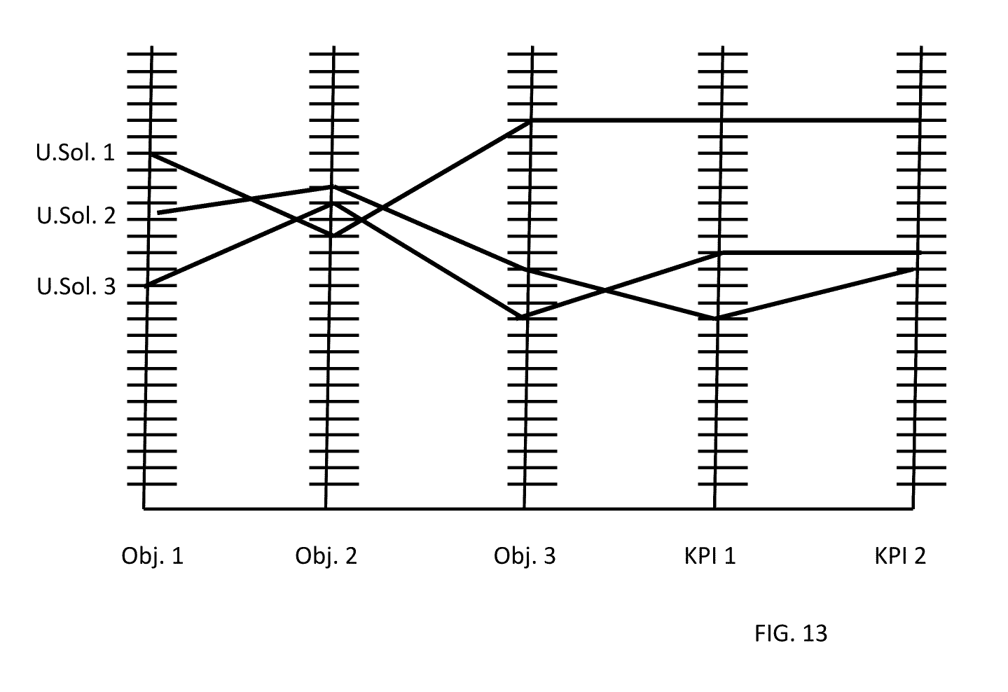

FIG. 13 shows graphically how different useful solutions may be better or worse than others in some objectives or KPI's. For any particular model, different strategies produce different behavior in the solutions (different values for objective functions and key performance indicators). The present disclosure generates multiple useful solutions to allow a decision maker to explore the solutions space. As shown, Sol. 1 has the best characteristics for objective 1, objective 3, and both KPIs. However, if objective 2 is more important for some business reason, the decision maker might prefer one of the other solutions shown.

This disclosure assists the user in the process of using the model to obtain practical solutions and simplifies the steps required to obtain new solutions when strategy parameters change or are adjusted, or if alternative strategies need to be explored. This flexibility is desirable because problems rarely are solved only once, but several times, at several points in time and by different users. This disclosure allows the use of the same mathematical model and avoids the requirement of involving an expert in modeling in case the strategy changes, making the tool much more useful for the non-expert user.

The execution engine reads the instructions given in the solution strategy file and follows the instructions, which include the administration and configuration of the solvers and interaction with the databases including the additional needed files.

This disclosure permits the use of parallel strategies in independent calls to the solver(s). Also, the database with files could be stored on a separate computer with its own programs to generate such files. The method is then separated from the data required and the solvers used to obtain partial solutions. This ability has an additional impact in the speed for large problems whose strategies admit parallelization.

The following is a concrete example problem situation based on a real project where several of the presented concepts can be visualized in a real context

Consider a supply chain for an industry in the production of glass containers. A supply chain problem of this type considers a given inventory of raw materials and a given demand of products of different kinds. The problem is to define several values in the production plants, inventory levels, flow of material and products and sales per client (including sales per client for each of several types of product).

There are 6 production plants in the company; each plant has 3 furnaces and approximately 10 Independent Section Machines to produce glass containers/bottles; these bottles may be sold as such or may pass through an additional coloring and finishing process. The finished products may be kept in inventory in the plant or transported to a warehouse where several inventory constraints are to be satisfied. The company may use outsourcing to complete demand if it is affordable to do so. Finally, the products are sold to national and international clients, ideally fully covering the estimated demand. Additionally, some clients may be more important than others, and so there may be other desirable constraints like satisfying the full demand of all first-tier clients before worrying about second-tier clients.

The goal is to design a system to help in the midterm planning of the supply chain, consistent with the outsourcing, production, inventory, distribution, and sales processes while monitoring the economic results and the production resources.

The following are the elements of the logistic network of the company and represent the information that is accessible to the company:
Products
Plants
Furnaces
Independent Section Machines
Type of finishing process
Production costs and standards
Warehouses
Routes
Clients
Demands

Examples of the kind of information in Plants we have data per period for:
Geographic position of each plant
Inventory capacity in each plant
Number of furnaces in each plant
Production capacities in each furnace
Hours that each furnace may be used
Colors available for each plant and each furnace
Number of Independent Section Machines per furnace
Production capacities and kind of product produced on each Independent Section Machine
Production speeds for each furnace/machine
Production costs in each furnace/machine

As a remark, the demand may be given by a forecast model, and it is generated continually or continuously in the company. Therefore, we have an estimate for the demand for a given number of periods in the future.

In this particular supply chain problem there are thousands of variables, which are structured in 11 classes by the model structure according to where in the chain they appear. The classes are the following:
1. Outsourcing Plants
2. Outsourcing warehouses
3. Production of glass bottles
4. Inventory of finished glass in plants
5. Production of finished glass
6. Inventory of finished glass in plants
7. Products sent between plants
8. Inventory of flat glass in warehouses
9. Inventory of finished glass in warehouses
10. Sales from plants
11. Sales from warehouses

The objectives of this problem are as follows:
1. Inventory policies (warrants service levels)
2. Cash flow
3. Cover demand
4. Marginal contribution
5. Production costs

There are also thousands of restrictions, but they may be classified in the following classes according to the model structure:
1. Machine capacities (color)
2. Independent Section Machine capacities
3. Finish capacity
4. Balance of inventory flat glass in plants
5. Balance of inventory finished glass in plants
6. Balance of inventory flat glass in warehouses
7. Balance of inventory finished glass in warehouses
8. Demand to cover per client
9. Inventory policies per product
10. Demand to cover
11. Revenue (sales)
12. Marginal contribution
13. Market participation (color)
14. Production costs
15. Demand to cover with priorities

To give an idea of the size of the decision model, a typical instance may have more than 600,000 variables along with more than 200,000 restrictions. It is not reasonable to manipulate such a huge model “by hand” each time the conditions for the decision change.

Normally, relatively few classes of variables are involved in the equations or inequalities representing the constraints of the problem. To give an example, the restrictions in the class of “Balance of inventory for glass bottles in warehouses” are a set of equations related only with four classes of variables: Outsourcing warehouses, products sent between plants, inventory of flat glass in warehouses, and sales from warehouses.

It is important to notice that once a model structure for the problem is defined, classifying the mathematical objects of the decision model into the correct categories, the previous sorts of observations are easy to discern.

For this situation, six different solution strategies (strategies) were proposed based on the behavior expected by the decision makers. We present two of these strategies.

The first strategy attempts to go only on the optimization of the marginal contribution as a business objective, which is estimated as the difference between sales income and total costs but respecting the inventory policies with no consideration of the client priorities.

The proposed strategy to meet this goal has only two transformations S₁, S₂. Let M₁ be the initial decision model.

Transformation S₁ performs the following steps:
1. Maximize marginal contribution.
2. Fix sales (client-product-period-quantity) as constants in the resulting model M₂.

Transformation S₂ performs the following steps:
1. Optimize using inventory policies.
2. Fix final inventory levels (product-period) as constants in the resulting model M₃.

The generated model M₃ after the two transformations is finally solved using the marginal contribution again as an objective.

For the second strategy, it is desirable to maximize the demand covering (fulfill the demand as much as possible) with a desired maximization of the marginal contribution, respecting client priorities and inventory politics. The client priorities mean that it is preferable to cover demand for high priority clients, unless the sale is not profitable.

This is a more realistic set of requirements, and the proposed strategy to meet this goal has three transformations S₁, S₂ S₃. Let M₁ be the initial decision model.

Transformation S₁, performs the following steps:
1. Maximize demand cover.
2. Fix total sales (in units), resulting in model M₂.

Transformation S₂ performs the following steps:
1. Maximize marginal contribution.
2. Fix sale variables (client-product-period-quantity) and generate a new model M₃.

Transformation S₃ performs the following steps:
1. Optimize inventory policies.
2. Fix final inventory levels per period and generate a model M₄.

The generated model M₄ after the transformations is finally solved using the marginal contribution again as an objective. As a result, the production and distribution is reallocated in a better way to improve the marginal contribution subject to the constraints introduced earlier in the solution strategy.

The computational tool allows the users to define strategies and make use of the initial model in many different ways, without changing the model (the equations). All equations and constraints are hidden from the final user. In a traditional approach, a complicated aggregated objective function has to be constructed, and only an experienced modeler may be able to do it properly. Further, many real world problems tend to generate excessively large models.

A particularly important point in favor of the disclosed novel approach is that the generated solutions tend to receive positive critiques from the point of view of decision makers in the sense that such solutions tend to be more practical.

The concept of strategies may also be used to explore situations and find risks and opportunities. One can compare the “costs” of a given inventory policy by constructing two strategies with or without such a policy and comparing the marginal costs. Users are very interested in measuring the cost of such a policy or other constraints.

Another concrete example, more simplified than the previous one, may assist in understanding the novel features of the present disclosure.

Consider a firm with three production plants and several customers. Assume the following:
Each plant is able to produce each of three different products.
Any customer may require any of the products in a given time period.
The demand of each client may be satisfied by production from any plant.
Production costs depend on the specific plant and product.
Distribution/delivery costs depends on plant and customer.
A given demand for each customer is known for a given period.
The firm wants to maximize profit by deciding how much of each product to produce in each plant and to which customer they will send the products.

This situation generates several mathematical objects and has the form of an optimization problem with the following function to be maximized:

F(X_{i,j,c}¹X_{i,j}²)=Σ_{i,j,c}P_{i,j}X_{i,j,c}¹−Σ_{i,j}C_{i,j}X_{i,j}²

where
X_{i,j,c}¹: Amount sold from plant i, of product j, to customer c.
X_{i,j}²: Amount produced in plant i, of product j.
P_{j,c}: Price of product j, for client c.
C_{i,j}: Production cost of one unit of product j, in plant i.

Such a function represents the difference between the total revenue and the total production costs, and is a natural objective to be maximized. The decision variables are classified in two groups.

Other mathematical objects represent restrictions related to the possible decisions. For example, the next expression represents the production capacity for plant i (the a's normalize the different products in order to compare them in a single equation).

Σⱼα_{i,j}X_{i,j}²≦Kᵢ,∀i

And the next expression represents the fact that you cannot sell more of product j than the demand of each customer c. The variable D is the demand of product j, by client c.

ΣᵢX_{i,j,c}¹≦D_{j,c}, ∀j,c

This is merely an example, and writing the full set of equations would only serve to overcomplicate it. There are in fact many other equations, but those shown above are enough to demonstrate some of the advantages of this disclosure.

In summary, these mathematical elements (equations, inequalities, and functions) have the form of an optimization problem. The utility function F has to be maximized while the constraints (equations and inequalities) are satisfied. Depending on the nature of the elements, there exist different software applications (like CPLEX, GUROBI, etc.) called “solvers” that obtain solutions for optimization problems.

However, as discussed above, these known products have several drawbacks in practice. Company policies may change at any moment, and the way of making decisions may change and are not made under a single criterion. Further, usually there is no simple function to be optimized. Here is an example of a decision strategy that might be proposed by a manager in the company in a given period: “We would like to maximize profit. But we won't cover the demand from our priority-2 customers before we are sure to be able to cover the demand of our priority-1 customers. However, this is only the desired outcome provided each sale is profitable. That is, if a priority-1 customer sale is not profitable, then we should be allowed not to cover its demand.” This relationship between the different elements of the solutions is referred to as “behavior” and may be different from one problem to another. This behavior includes a set of desired qualitative characteristics of a variable or group of variables in the solution of a model.

Those characteristics are associated with the meaning of the different groups of variables. To obtain a specific behavior, the strategy favors certain variables above others, given the fact that certain variables are more relevant than others from the perspective of the problem owner. Different strategies, when applied to a model, produce solutions with different behaviors.

There are behaviors that make more sense to the problem owner given the meaning of the different variables in the context of the problem we are trying to solve.

If we want to include such a behavior in the model, the traditional approach is to include a set of additional variables in the model and a list of restrictions and modify the function to be maximized to reflect the desired behavior. Such a task is not simple, and considerable expertise in modeling and optimization is required in order to construct such a model. We call to the set of priority-1 customers “A” and the set of other customers “B.” A typical approach is the following.

With the purpose being to include a penalty factor in the function to be maximized, define the following set of binary variables, hⱼ. The b's are weights to be estimated by the modeler in order to reflect the required behavior.

$${h}_{j} = \{ \begin{matrix}1 & demand not covered for product j \\ 0 & demand is covered for product j\end{matrix} \\ {F}^{′} = F - {\sum }_{j} {b}_{j} {h}_{j}$$

New equations then appear as constraints related to these new binary variables.

(Σ_{i,c}X_{i,j,c}¹−Σ_{c∈A}D_{j,c})+Mhⱼ≧0, ∀j

If the demand of clients in A is not satisfied for a product, h is forced to be 1 (demand not covered).

Σ_{i,c∈B}X_{i,j,c}¹≦M′(1−hⱼ),∀j

Each product where the demand is not satisfied forces the sales to clients in B to be zero.

In the first inequality, M is a “suitably large” number and it assures that we meet the demand of the A group.

The number of equations grows proportional to the number of products. In real problems thousands of equations and variables will be included, and their binary nature makes them even more complex and requires more time to find a solution. In many cases, the generated problem may become so large that it is simply not feasible to solve them numerically.

Even if the size of the new problem is tractable, the corresponding transformations in the model must be performed by an experienced modeler, and it becomes very easy to make mistakes. Additionally, a set of parameters (a, M, M′, . . . ) needs to be estimated from experience and understanding of both reality and the mathematical model.

The traditional approach only involves transformations to the mathematical model and ignores the corresponding meaning of the mathematical objects involved as related to the real problem. In contrast, the present disclosure translates the decision strategy into a specific procedure that generates at the end a decision point with the characteristics required by the decision maker. As above, the given decision strategy in this example is: “We won't cover the demand of a given subset B of our customers before we are sure to be able to cover the demand of another subset A, provided that each sale to A is profitable.

We include two additional functions/variables to the original model defined as:

g₁=Σ_{i,j,c∈A}P_{i,c}X_{i,j,c}¹−Σ_{i,j}C_{i,j}X_{i,j}²

g₂=Σ_{i,j,c}P_{j,c}X_{i,j,c}¹−Σ_{i,j}C_{i,j}X_{i,j}²

We then perform the following steps as instructions:
Optimize original model with F=S₁
Fix values of X¹_{ijc}(or restrict them to an interval)
Optimize model with _{F=S2} (assuming variables X¹_{ijc} are fixed for clients in A)

Clearly, the changes to the original model are minimal and easy to implement. The size of the problem is almost maintained, the obtained decision point reflects in a direct way the preferences of the decision maker according to his strategy. In addition, this disclosure is able to use solutions obtained from previous steps as starting points for the calls of the solvers in subsequent steps. This reuse accelerates the execution of the whole process. Future modifications of the strategy are easily implemented with no need to make complicated adjustments to the mathematical model. The ability to explore different strategies is also useful even if a single person is using the tool simply to explore alternative points of view in relation to important issues of the real situation.

The present disclosure allows a user to construct a strategy in whatever way is convenient or desirable for the problem at hand. However, it also includes a pre-built library of strategies, which may be used as-is, combined, or edited and saved by the user. Some of the library strategies are as follows.

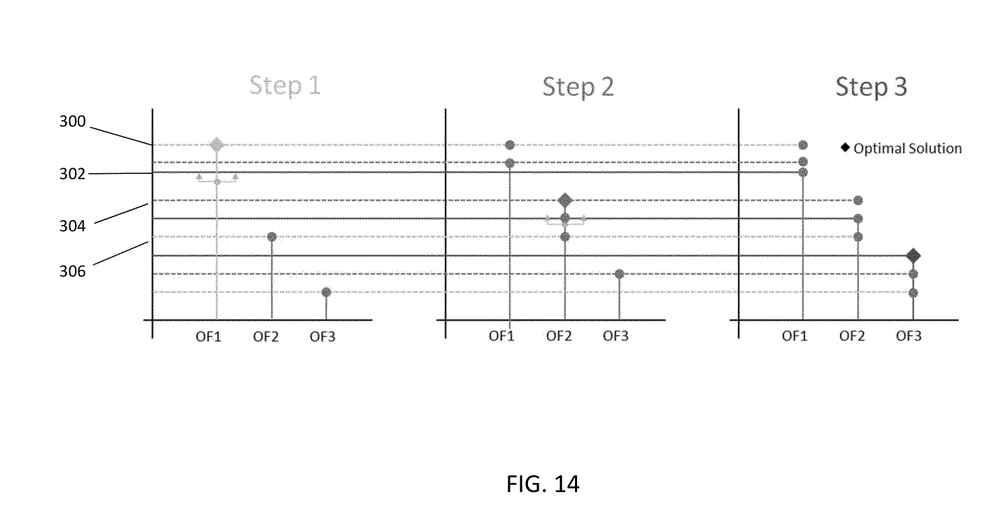

MO_STD (standard multi-objective) is the most basic primitive strategy, and it is demonstrated schematically at FIG. 14. It uses the optimization of at least two objective functions in sequence, where the optimal value of an initial objective function is relaxed before the optimal for a subsequent objective function is searched.

To relax an objective function is to define a range of acceptable values around the optimal value.

One way to do that is the following:
The model to be solved should contain at least two objective functions
All the objective functions should be represented within the model as a constraint.
To represent an objective function as a constraint a variable is introduced into the equation. This allows the possibility to set limits to the whole equation, that is to relax it, more easily.
Only one variable representing an objective function can be set active at a given moment.

As shown in FIG. 14, at step 1, we first find a solution with the maximum possible value 300 for objective function 1 (OF1), and we then restrict ourselves to solutions where the value of OF1 is at least a certain value 302.

At step 2, we find a solution with the maximum possible value 304 for OF2 given the constraint on OF1. We then choose a certain minimum value 306 for OF2 and restrict ourselves to solutions where OF1 is greater than or equal to value 302 and OF2 is greater than or equal to value 306. We then do the same thing for OF3.

(This approach of course also extends to maximum values for the objective functions as well as minimum values.) This allows a rational approach to a final solution that is useful in the real world.

MO_POL (multi-objective with policies): extends the behavior of the MO_STD strategy. It allows the possibility to optimize at least two objective functions in sequence. For at least one objective function the optimal values of all the variables that are part of this objective function equation are relaxed before the optimal values for the second objective function are searched.

One way to do that is the following:
The model to be solved should contain at least one objective function and a second objective function that may represent a goal or policy.
The objective functions should be represented within the model as a constraint.
To represent an objective function as a constraint, a variable is introduced into the equation. This allows the possibility to set limits, to the whole equation, that is to relax it, more easily.
A goal (policy) allows defining the value ranges of some variables to adhere to specific business practices. It is defined as an equation composed of all the variables that are related to the business practice that we want to adhere to, as well as its respective deviation variables.
Only one variable representing the objective function or the goal equation can be set active at a given moment.

MO_SETEOS (multi-objective with settings) is a primitive strategy that extends the behavior of the MO_POL strategy by allowing the possibility to manually manipulate any variable of the equations system. These interactions with the model are made through the use of the “Set” and “Get” operations. The Set operation allows defining limits to any given variable of the equations system. The Get operation allows saving the value of any given variable after an optimization of the equations system to make use of that value in subsequent steps of the strategy.

One way to do that is the following:
The model to be solved should contain at least two objective functions; one or more of them may be a goal or policy.
The objective functions should be represented within the model as a constraint.
To represent an objective function as a constraint a variable is introduced into the equation. This allows the possibility to set limits, to the whole equation, that is to relax it, more easily.
A goal allows defining the value ranges of some variables to adhere to specific business practices. It is defined as an equation composed of all the variables that are related to the business practice that we want to adhere to, as well as its respective deviation variables.
Only one variable representing the objective function or the goal (policy) equation can be set active at a given moment.

MO_BATCH (batch) is a strategy that executes two or more primitive strategies in sequence.

PARAMETRIC is a strategy that executes one primitive strategy in a loop with different values for a particular parameter. A set of rules is defined to decide whether the execution should continue after the end of each loop. The values of any variable of the equation system may be stored at any given loop for further use and reporting. The equations system may be changed based on a list of modifications at any given loop iteration.

INDEPENDENT is a strategy that executes two or more optimizations in sequence, where no limits or settings from one optimization carry forward to the next.

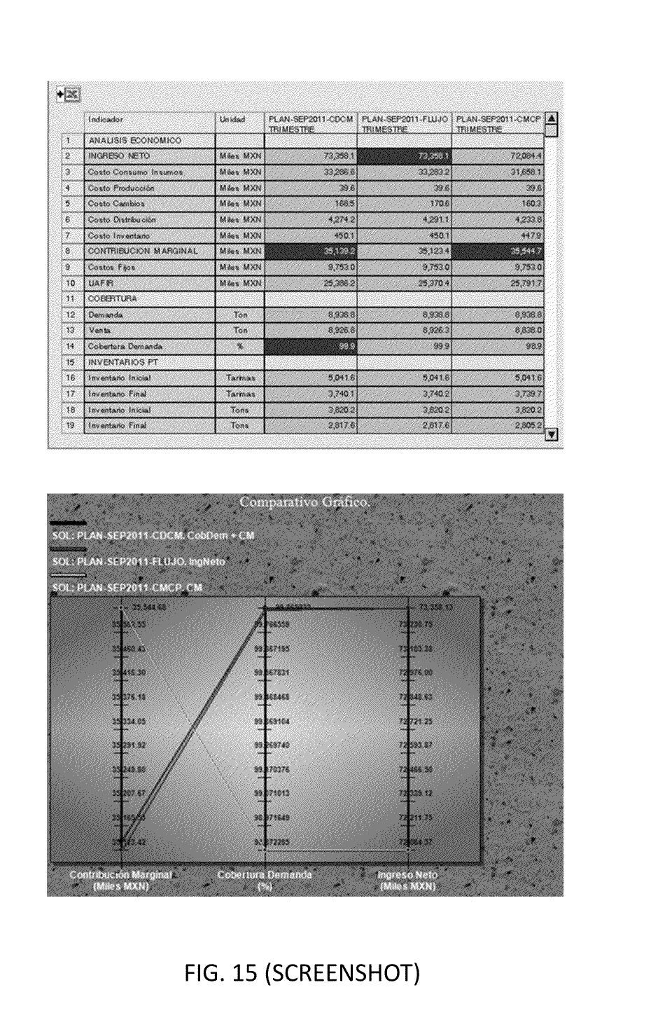

FIG. 15 shows screenshots according to the present disclosure. As shown, different useful solutions may be visually evaluated according to their performance in different objective functions and key performance indicators.

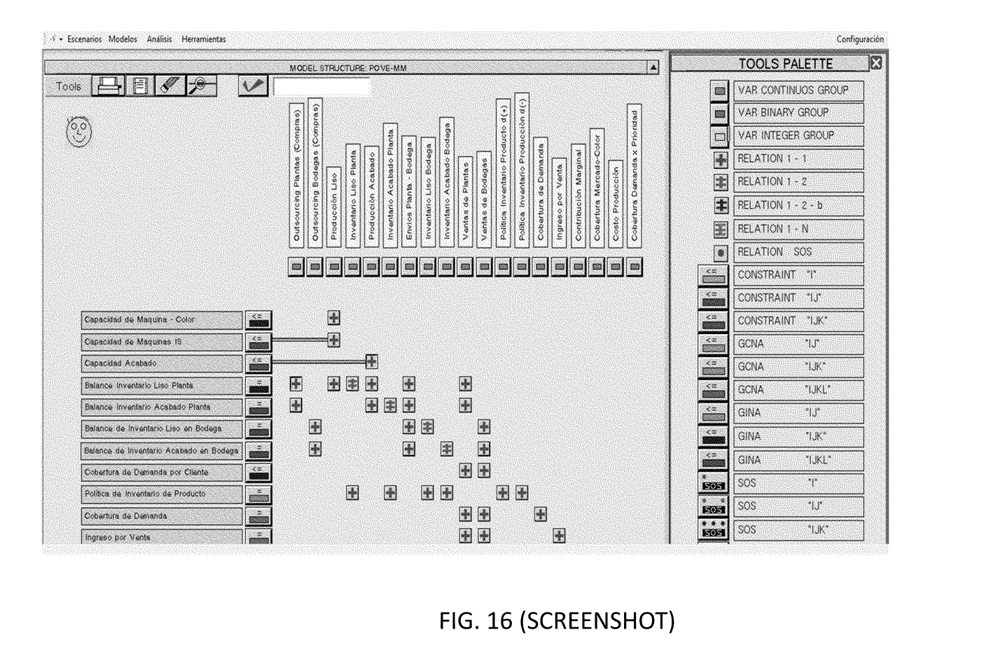

FIG. 16 shows a screenshot of a meta-modeling environment of the present disclosure. This environment allows a user to visually create various types of connections between the various types of variables, which may apply to wide ranges of particular real-world situations. By specializing a meta-model such as the ‘one shown, a user can create a model structure that fits a particular situation. The use of the meta-model makes easier to create the required A1, A2 and A3 files.

Those with ordinary skill in the art will recognize that the disclosed embodiments have relevance to a wide variety of areas in addition to those specific examples described above.

The foregoing description of the exemplary embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

It is intended that all such additional systems, methods, features, and advantages that are included within this description be within the scope of the claims.

What is claimed is:

1. A computer-implemented method for solving an optimization problem, said method comprising:
accepting a model, said model comprising a collection of mathematical objects representing said optimization problem and at least one objective to be maximized or minimized;
accepting a strategy, said strategy comprising a plurality of instructions for manipulating said model via a plurality of model-independent quantities;
accepting a model structure, said model structure comprising an index correlating said plurality of model-independent quantities to said collection of mathematical objects;
validating said model against said model structure for consistency;
validating said strategy against said model structure for consistency;
executing a first at least one command from said strategy, and thereby preparing a first solver input comprising at least a first objective;
passing said first solver input to said solver, said solver generating a first solution based on said first solver input;
reading said first solution;
executing a second at least one command from said strategy, and thereby preparing a second solver input comprising at least a second objective, said second objective being different from said first objective;
passing said second solver input to said solver, said solver generating a second solution different from said first solution based on said second solver input; and
reading said second solution.

2. The method of claim 1, wherein said second solver input is a function of said first solution.

3. The method of claim 1, wherein said second solver input is independent of said first solution.

4. The method of claim 1, wherein said solver comprises multiple independent solvers mediated by a broker component.

5. The method of claim 4, wherein said multiple independent solvers run on separate physical machines.

6. The method of claim 1, wherein said strategy is written in a domain-specific language.

7. The method of claim 6, wherein said DSL includes instructions for calling one or more solvers, instructions for solver resource management, instructions for adjustment of said model, instructions for solver configuration, and instructions for solver optimization.

8. The method of claim 6, wherein said domain-specific language comprises a solver-independent domain-specific language.

9. The method of claim 1, wherein said strategy comprises a library of predefined strategy components, said library including at least two strategy components chosen from the group consisting of:
standard multiple-objective, comprising optimization of at least two objective functions in sequence, wherein the optimal value of an initial objective function is relaxed before an optimal for a subsequent objective function is searched;
multiple-objective with policies, comprising minimizing a deviation of a particular variable;
multiple-objective with settings, comprising manually manipulating at least one variable;
batch multiple-objective, comprising executing at least two primitive strategies in sequence;
parametric, comprising solving multiple times with different values of at least one parameter; and
independent, wherein two or more optimizations are executed independently in sequence or in parallel.

10. The method of claim 1, further comprising classifying said solutions based on expected behavior, risks, and opportunities.

11. The method of claim 1, further comprising storing said first solution for later retrieval.

12. The method of claim 11, further comprising using said stored first solution in preparing said second solver input.

13. The method of claim 1, further comprising executing said strategy via an interactive read-evaluate-print loop.

14. The method of claim 1, wherein said strategy is defined in a model-independent manner.

15. An apparatus for solving an optimization problem, said apparatus comprising a computer encoded with instructions for executing the following steps:
accepting a model, said model comprising a collection of mathematical objects representing said optimization problem and at least one objective to be maximized or minimized;
accepting a strategy, said strategy comprising a plurality of instructions for manipulating said model via a plurality of model-independent quantities;
accepting a model structure, said model structure comprising an index correlating said plurality of model-independent quantities to said collection of mathematical objects;
validating said model against said model structure for consistency;
validating said strategy against said model structure for consistency;
executing a first at least one command from said strategy, and thereby preparing a first solver input comprising at least a first objective;
passing said first solver input to said solver, said solver generating a first solution based on said first solver input;
reading said first solution;
executing a second at least one command from said strategy, and thereby preparing a second solver input comprising at least a second objective, said second objective being different from said first objective;
passing said second solver input to said solver, said solver generating a second solution different from said first solution based on said second solver input; and
reading said second solution.

16. The apparatus of claim 15, wherein said second solver input is a function of said first solution.

17. The apparatus of claim 15, wherein said second solver input is independent of said first solution.

18. The apparatus of claim 15, wherein said solver comprises multiple independent solvers mediated by a broker component.

19. The apparatus of claim 18, wherein said multiple independent solvers run on separate physical machines.

20. The apparatus of claim 15, wherein said strategy is written in a domain-specific language.

21. The apparatus of claim 20, wherein said DSL includes instructions for calling one or more solvers, instructions for solver resource management, instructions for adjustment of said model, instructions for solver configuration, and instructions for solver optimization.

22. The apparatus of claim 20, wherein said domain-specific language comprises a solver-independent domain-specific language.

23. The apparatus of claim 15, wherein said strategy comprises a library of predefined strategy components, said library including at least two strategy components chosen from the group consisting of :
standard multiple-objective, comprising optimization of at least two objective functions in sequence, wherein the optimal value of an initial objective function is relaxed before an optimal for a subsequent objective function is searched;
multiple-objective with policies, comprising minimizing a deviation of a particular variable;
multiple-objective with settings, comprising manually manipulating at least one variable;
batch multiple-objective, comprising executing at least two primitive strategies in sequence;
parametric, comprising solving multiple times with different values of at least one parameter; and
independent, wherein two or more optimizations are executed independently in sequence or in parallel.

24. The apparatus of claim 15, further comprising classifying said solutions based on expected behavior, risks, and opportunities.

25. The apparatus of claim 15, further comprising storing said first solution for later retrieval.

26. The apparatus of claim 25, further comprising using said stored first solution in preparing said second solver input.

27. The apparatus of claim 15, further comprising executing said strategy via an interactive read-evaluate-print loop.

28. The apparatus of claim 15, wherein said strategy is defined in a model-independent manner.
